(19) United States
(12) Patent Application Publication
(10) Pub. No.: US 2019/0025135 A1
(43) Pub. Date: Jan. 24, 2019

(54) NON-LINEARITY CORRECTION TECHNIQUE FOR TEMPERATURE SENSOR IN DIGITAL POWER SUPPLY

(71) Applicant: QUALCOMM Incorporated, San Diego, CA (US)

(72) Inventors: Junmou ZHANG, San Diego, CA (US); Guoan ZHONG, San Diego, CA (US); Nan CHEN, San Diego, CA (US)

(21) Appl. No.: 15/657,887

(22) Filed: Jul. 24, 2017

(51) Int. Cl. G01K 7/32; G05F 1/59

(52) U.S. Cl. CPC G01K 7/32; G05F 1/59

(57) ABSTRACT

Certain aspects of the present disclosure provide apparatus and techniques for sensing a temperature. For example, certain aspects of the present disclosure may provide a temperature sensing circuit. The temperature sensing circuit may include a first current mirror having a first branch coupled to a first transistor, a resistive element coupled between a source of the first transistor and a reference potential, and a second current mirror having a first branch coupled to a second transistor. In certain aspects, a source of the second transistor may be coupled to the reference potential, and a gate of the first transistor may be coupled to a gate of the second transistor. In certain aspects, the temperature sensing circuit may also include an oscillator having an input coupled to a third transistor of the second current mirror.

### TECHNICAL FIELD

The teachings of the present disclosure relate generally to a circuit, and more particularly, to a circuit for sensing temperature.

### INTRODUCTION

Computing devices are ubiquitous. Some computing devices are portable such as mobile phones, tablets, and laptop computers. As the functionality of such portable computing devices increases, the computing or processing power required to support such functionality also increases. For example, mobile computing device architectures have grown in complexity, and now commonly include multiple processor cores co-processors, functional modules including dedicated processors, complex memory systems, intricate electrical interconnections (e.g., buses and/or fabrics), and numerous other resources that execute complex and power intensive software applications (e.g., video streaming applications, etc.). With this rise in complexity, temperature management solutions are becoming more and more important to improve the computational and power management performance of mobile devices.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects of the present disclosure provide apparatus and techniques for sensing a temperature.

Certain aspects of the present disclosure may provide a temperature sensing circuit. The temperature sensing circuit may include a first current mirror having a first branch coupled to a first transistor, a resistive element coupled between a source of the first transistor and a reference potential, and a second current mirror having a first branch coupled to a second transistor. In certain aspects, a source of the second transistor may be coupled to the reference potential, and a gate of the first transistor may be coupled to a gate of the second transistor. In certain aspects, the temperature sensing circuit may also include an oscillator having an input coupled to a third transistor of the second current mirror.

Certain aspects of the present disclosure may provide a method for sensing a temperature. The method generally includes generating a first current that is proportional to the temperature, controlling a frequency of an oscillating signal based on the first current, and generating a signal indicative of the temperature based on the oscillating signal.

Certain aspects of the present disclosure may provide an apparatus for sensing a temperature. The apparatus generally includes means for generating a first current that is proportional to the temperature, means for controlling a frequency of an oscillating signal based on the first current, and means for generating a signal indicative of the temperature based on the oscillating signal.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is an illustration of an exemplary system-on-chip (SoC) integrated circuit design, in accordance with certain aspects of the present disclosure.

FIG. 2 illustrates an example temperature sensing circuit, in accordance with certain aspects of the present disclosure.

FIG. 3 is a graph illustrating the gate-to-source voltage difference (ΔVGS) of transistors of a temperature sensing circuit, in accordance with certain aspects of the present disclosure.

FIG. 4 is a graph illustrating a frequency of an oscillating signal as a function of control current, in accordance with certain aspects of the present disclosure.

FIG. 5 is an example inverter that may be used in an oscillator, in accordance with certain aspects of the present disclosure.

FIG. 6 is a graph illustrating the accuracy of an oscillator as a function control current, in accordance with certain aspects of the present disclosure.

FIG. 7 illustrates the accuracy of the temperature sensing circuit of FIG. 2 as a function of temperature, in accordance with certain aspects of the present disclosure.

FIG. 8 is a flow diagram of example operations for sensing a temperature, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “computing device” and “mobile device” are used interchangeably herein to refer to any one or all of servers, personal computers, smartphones, cellular telephones, tablet computers, laptop computers, netbooks, ultrabooks, palm-top computers, personal data assistants (PDA's), wireless electronic mail receivers, multimedia Internet enabled cellular telephones, Global Positioning System (GPS) receivers, wireless gaming controllers, and similar personal electronic devices which include a programmable processor. While the various aspects are particularly useful in mobile devices (e.g., smartphones, laptop computers, etc.), which have limited resources (e.g., processing power, battery, etc.), the aspects are generally useful in any computing device that may benefit from improved processor performance and reduced energy consumption.

The term “multicore processor” is used herein to refer to a single integrated circuit (IC) chip or chip package that contains two or more independent processing units or cores (e.g., CPU cores, etc.) configured to read and execute program instructions. The term “multiprocessor” is used herein to refer to a system or device that includes two or more processing units configured to read and execute program instructions.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects. Such memory technologies/types include phase change memory (PRAM), dynamic random-access memory (DRAM), static random-access memory (SRAM), non-volatile random-access memory (NVRAM), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory. Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language.

Mobile computing device architectures have grown in complexity, and now commonly include multiple processor cores, SoCs, co-processors, functional modules including dedicated processors (e.g., communication modem chips, GPS receivers, etc.), complex memory systems, intricate electrical interconnections (e.g., buses and/or fabrics), and numerous other resources that execute complex and power intensive software applications (e.g., video streaming applications, etc.). With this rise in complexity, new temperature management solutions may be needed to improve the computational and power management performance of mobile devices.

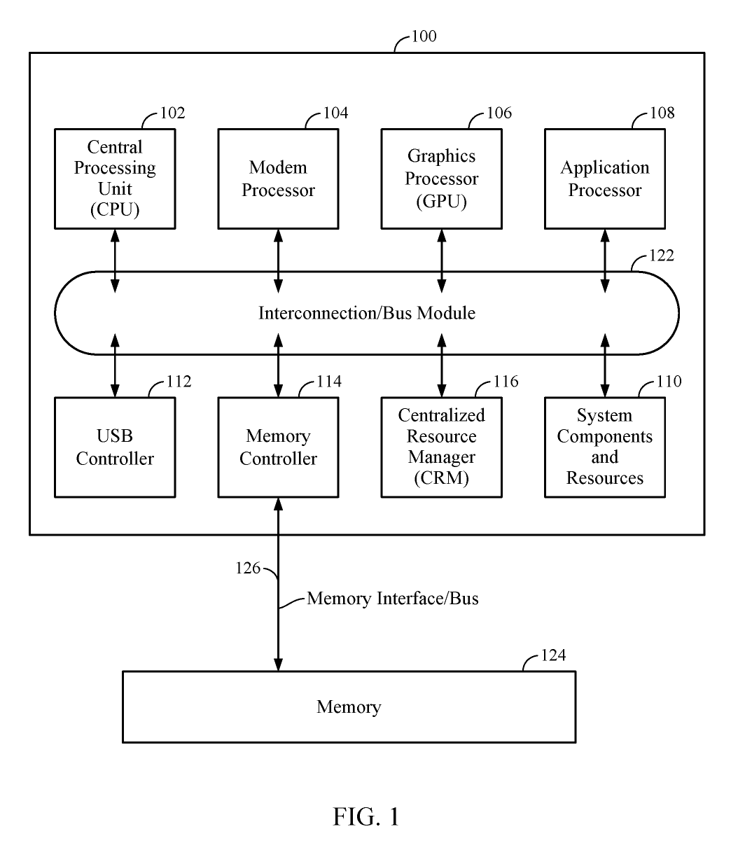

FIG. 1 illustrates example components and interconnections in a system-on-chip (SoC) 100 suitable for implementing various aspects of the present disclosure. The SoC 100 may include a number of heterogeneous processors, such as a central processing unit (CPU) 102, a modem processor 104, a graphics processor 106, and an application processor 108. Each processor 102, 104, 106, 108, may include one or more cores, and each processor/core may perform operations independent of the other processors/cores. The processors 102, 104, 106, 108 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The SoC 100 may include system components and resources 110 for managing sensor data, analog-to-digital conversions, wireless data transmissions, and for performing other specialized operations (e.g., decoding high-definition video, video processing, etc.). System components and resources 110 may also include components such as voltage regulators, oscillators, phase-locked loops, peripheral bridges, data controllers, system controllers, access ports, timers, and other similar components used to support the processors and software clients running on the computing device. The system components and resources 110 may also include circuitry for interfacing with peripheral devices, such as cameras, electronic displays, wireless communication devices, external memory chips, etc.

The SoC 100 may further include a universal serial bus controller 112, one or more memory controllers 114 (e.g., a dynamic random access memory (DRAM) memory controller), and a centralized resource manager (CRM) 116. The SoC 100 may also include an input/output module (not illustrated) for communicating with resources external to the SoC each of which may be shared by two or more of the internal SoC components.

The processors 102, 104, 106, 108 may be interconnected to the USB controller 112, the memory controller 114, system components and resources 110, CRM 116, and other system components via an interconnection/bus module 122, which may include an array of reconfigurable logic gates and/or implement a bus architecture (e.g., CoreConnect, AMBA, etc.). Communications may also be provided by advanced interconnects, such as high performance networks-on chip (NoCs).

The interconnection/bus module 122 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In an aspect, the bus module 122 may include a direct memory access (DMA) controller (not illustrated) that enables components connected to the bus module 122 to operate as a master component and initiate memory transactions. The bus module 122 may also implement an arbitration scheme to prevent multiple master components from attempting to drive the bus simultaneously.

The memory controller 114 may be a specialized hardware module configured to manage the flow of data to and from a memory 124 (e.g., DRAM, RAM, etc.) via a memory interface/bus 126. For example, the memory controller 114 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In certain aspects, the memory 124 may be part of the SoC 100.

For deep sub-micron processes, the heat generated from circuit operations may become a bottle neck due to the number of transistor in a small die. Certain aspects of the present disclosure are generally directed to thermal management techniques to mitigate heat issues. For example, a large amount of temperature sensors may be placed in small grid (e.g., across various locations in the SoC 100) to pinpoint the hot spots on the die. Therefore, it is important for the temperature sensor to have a small area and be digital flow friendly. Certain aspects of the present disclosure provide a temperature sensor that uses a digital power supply while providing an accurate temperature value. For example, certain aspects of the present disclosure provide a non-linearity compensation technique to achieve high accuracy for temperature sensing.

Aspects of the present disclosure also provide techniques for generating digital outputs from densely-placed sensors to provide the temperature across the die as input to a thermal management or other limit managements (e.g. leakage) device (e.g., the CPU 102). Moreover, the temperature sensor described herein may be placed under a memory power supply as it can be operated without a dedicated analog power supply, avoiding analog routing which disrupts the digital and physical design flow.

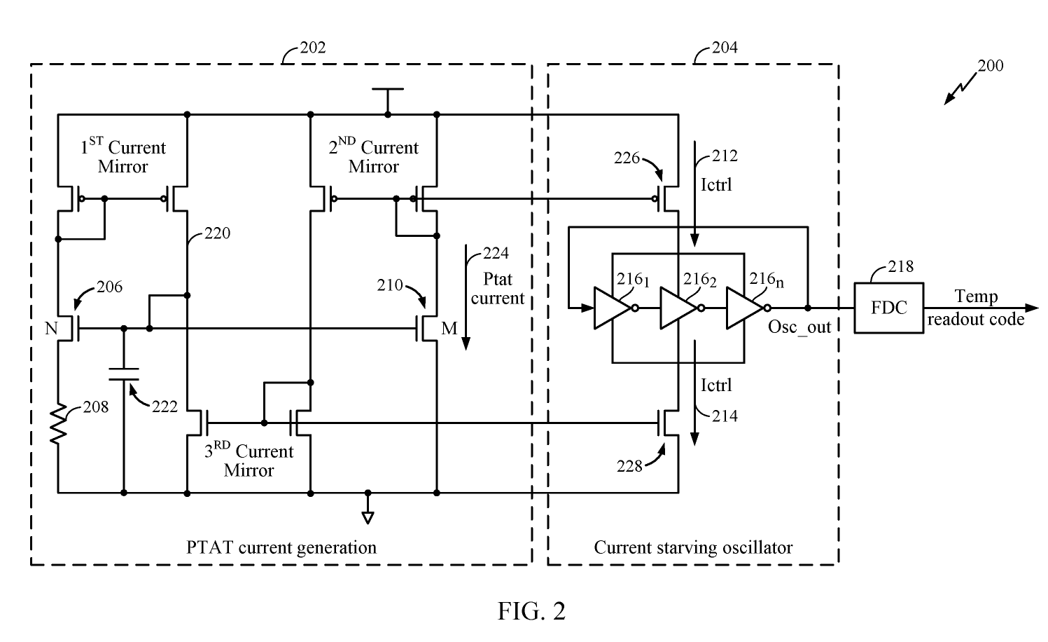

FIG. 2 illustrates an example temperature sensing circuit 200, in accordance with certain aspects of the present disclosure. As illustrated, the temperature sensing circuit 200 includes a proportional to ambient temperature (PTAT) current generation circuit 202 and an oscillator 204 (e.g., ring oscillator). In certain aspects, the PTAT current generation circuit 202 may include a first current mirror having a branch coupled to a transistor 206, and a resistive element 208 coupled between a source of the transistor 206 and a reference potential (e.g., electric ground). The PTAT current generation circuit 202 also includes a second current mirror having a branch coupled to a transistor 210. A source of the transistor 210 is coupled to the reference potential and the gate of the transistor 206 is coupled to the gate of the transistor 210.

In certain aspects, a third current mirror may be coupled to the first and second current mirrors, as illustrated. The PTAT current generation circuit 202 may include a feedback loop by coupling node 220 to the gates of transistors 206 and 210, as illustrated. The gates of the transistors 206 and 210 may be low-pass filtered using a capacitor 222. In certain aspects, the size (N) of the transistors 206 may be different than a size M of the transistor 210. Moreover, the difference between the gate to source voltage (hereinafter ΔV_{GS}) of the transistors 206 and 210 is equal to the voltage drop across the resistive element 208, which is equal to the drain current of transistors 206 multiplied by the resistance of the resistive element 208.

In the subthreshold region, a metal-oxide semiconductor (MOS) transistor behaves similar to a bipolar transistor with an exponential relationship between the drain current i_{D} and gate voltage. For example, the drain current in the subthreshold region of the transistors 206 and 210 may be calculated based on the equation:

$${i}_{D ( subthreshold} \approx \frac{W}{L} {μ}_{e} {{C}_{ox} ( \frac{kT}{q} )}^{2} ( n - 1 ) {e}^{q ( {V}_{GS} - {V}_{th} ) / nkT} ( 1 - {e}^{{qV}_{DS} / kT} )$$

where W is the width of the transistor, L is the length of the transistor, μ_{c} is the charge-carrier effective mobility, Cox is gate oxide capacitance per unit area, k is the Boltzmann's constant, T is the absolute temperature, q is the electronic charge, n is the ideality factor, V_{T}=kT/q=25.85 mV at T=300 K, and V_{DS} is the drain to source voltage. The term:

(1−e^{q}^{^{V}}^{_{DS}}^{/kT})

of the equation may be about equal to 1, and thus, may be ignored in some implementations. If this term is ignored, the equation for ΔV_{GS} (i.e., the difference between the gate to source voltage of the transistors 206 and 210) shown below represents an ideal ΔV_{GS} as it is a linear function of temperature T. Thus, an ideal (e.g., linear to temperature) ΔV_{GS} may be equal to:

ΔV_{gs}=ln(N)(nV_{T})

where N is defined as:

$$N = {e}^{\frac{( Δ {V}_{gs} )}{{nV}_{T}}} \frac{1 - {e}^{\frac{- Vds 1}{{V}_{T}}}}{1 - {e}^{\frac{- Vds 2}{T}}}$$

where V_{ds1} is the drain to source voltage of transistor 206 and the V_{ds2} is the drain to source voltage of transistor 210. However, V_{DS} introduces a second order effect that causes a non-linearity in the ΔV_{GS} as a function of temperature T. For example, the drain current Id may be calculated as:

$$Id = K \frac{W}{L} {e}^{\frac{( {V}_{gs} - {V}_{th}}{{nV}_{T}}} ( 1 - {e}^{\frac{- Vds}{{V}_{T}}} )$$

and ΔV_{GS} may be equal to:

$$Δ {V}_{gs} = {nV}_{T} ln ( N \frac{1 - {e}^{\frac{- Vds 2}{{V}_{T}}}}{1 - {e}^{\frac{- Vds 1}{{V}_{T}}}} )$$

Then ΔV_{GS} can be simplified as follows:

$$\begin{matrix}Δ {V}_{gs} = {nV}_{T} [ ln ( N ) + ln ( 1 - {e}^{\frac{- Vds 2}{{V}_{T}}} ) - ln ( 1 - {e}^{\frac{- Vds 1}{{V}_{T}}} ) ] \\ = {nV}_{T} [ ln ( N ) + ( - {e}^{\frac{- Vds 2}{{V}_{T}}} ) - ( - {e}^{\frac{- Vds 1}{{V}_{T}}} ) ] \\ = {nV}_{T} [ ln ( N ) - {e}^{\frac{- Vds 2}{{V}_{T}}} + {e}^{\frac{- Vds 1}{{V}_{T}}} ] \\ \approx {nV}_{T} [ ln ( N ) - ( a 0 + a 1 * \frac{Vds 2}{{V}_{T}} + a 2 * ( \frac{Vds 2}{{V}_{T}} ) 2 ) + \\ ( a 0 + a 1 * \frac{Vds 1}{{V}_{T}} + a 2 * ( \frac{Vds 1}{{V}_{T}} ) 2 ) ] \\ = {nV}_{T} [ ln ( N ) + a 1 \frac{Vds 1 - Vds 2}{{V}_{T}} + a 2 \frac{{V}_{ds 1}^{2} - {V}_{ds 2}^{2}}{{V}_{T}^{2}} ] \\ = {nV}_{T} ln ( N ) + na 1 ( Vds 1 - Vds 2 ) + na 2 \frac{{V}_{ds 1}^{2} - {V}_{ds 2}^{2}}{{V}_{T}} \\ = {nV}_{T} ln ( N ) + na 1 ( Δ {V}_{gs} ) + na 2 \frac{{V}_{ds 1}^{2} - {V}_{ds 2}^{2}}{{V}_{T}} \\ = \frac{{nV}_{T} ln ( N )}{1 - na 1} + \frac{na 2}{1 - na 1} \frac{{V}_{ds 1}^{2} - {V}_{ds 2}^{2}}{{V}_{T}} \\ = \text{∼} {nV}_{T} ln ( N ) + \frac{na 2}{1 - na 1} ( {V}_{ds 1}^{2} - {V}_{ds 2}^{2} ) \frac{q}{kT}\end{matrix}$$

where a0, a1, and a2 are coefficients of a polynomial equation. Therefore, the ΔV_{GS} is equal to the ideal ΔV_{GS} (linear with respect to T) as described above, multiplied by an inverse function of temperature T. Thus, the V_{DS} effect on the subthreshold current introduces a variable that is an inverse function of temperature T, causing a curvature in the PTAT voltage generated by the temperature sensing circuit 200. This non-linearity due to the effect of V_{DS} exists in both low voltage threshold (LVT) and standard voltage threshold (SVT) devices. The non-linearity reduces accuracy when reporting the PTAT voltage for temperature determination.

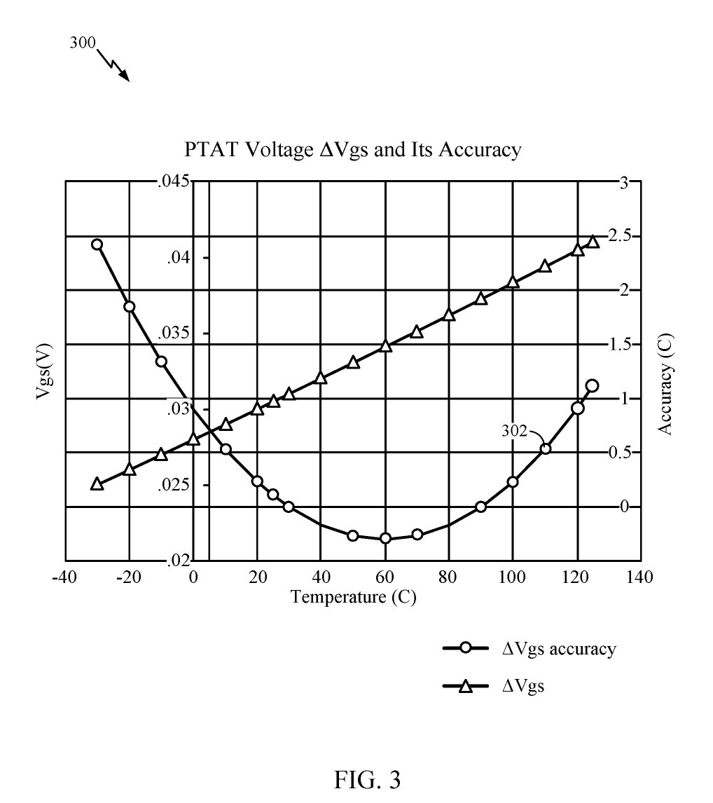

FIG. 3 is a graph 300 illustrating the ΔV_{GS} and the accuracy of the same as a function of temperature, in accordance with certain aspects of the present disclosure. Due to the V_{DS} term as described above, the accuracy of ΔV_{GS} varies based on temperature as illustrated by the curve 302 having an upward curvature. As illustrated in FIG. 2, the PTAT current generation circuit 202 is coupled to an oscillator 204. For example, the PTAT current may be mirrored to generate control currents (Ictrl) to control the frequency of the output signal (osc_out) of the oscillator 204, such that the frequency of osc_out is indicative of the detected temperature. For example, transistors 226 and 228 may be coupled to the positive and negative voltage rails of the oscillator 204, respectively. The gates of the transistors 226 and 228 may coupled to gates of transistors of the second and third current mirrors, respectively, to generate the Ictrl based on the PTAT current. The oscillator 204 effectively counteracts the non-linearity of the PTAT current generation circuit 202, reducing the inaccuracy in temperature sensing, as will be described in more detail herein.

In certain aspects, the oscillator 204 may be a current starved ring oscillator. The frequency of a signal at the output of the oscillator 204 depends on the delay introduced by each of the inverters 216. This delay can be controlled by controlling an amount of time it takes to charge or discharge the gate capacitance of the inverters 216 by controlling an amount of current available for the charging and discharging. Thus, the control current 212 (Ictrl), which mirrors the PTAT current 224, sourced to the positive voltage rails of the inverters 216 may be about the same as the Ictrl 214 sinked from the negative voltage rails of the inverters 216 to the reference potential (e.g., electric ground). The oscillator 204 generates a signal having a frequency that is adjusted based on the PTAT current 224. The output of the oscillator may be coupled to a frequency to digital converter (FDC) 218 to provide a digital readout of the frequency at the output of the oscillator that is indicative of the detected temperature.

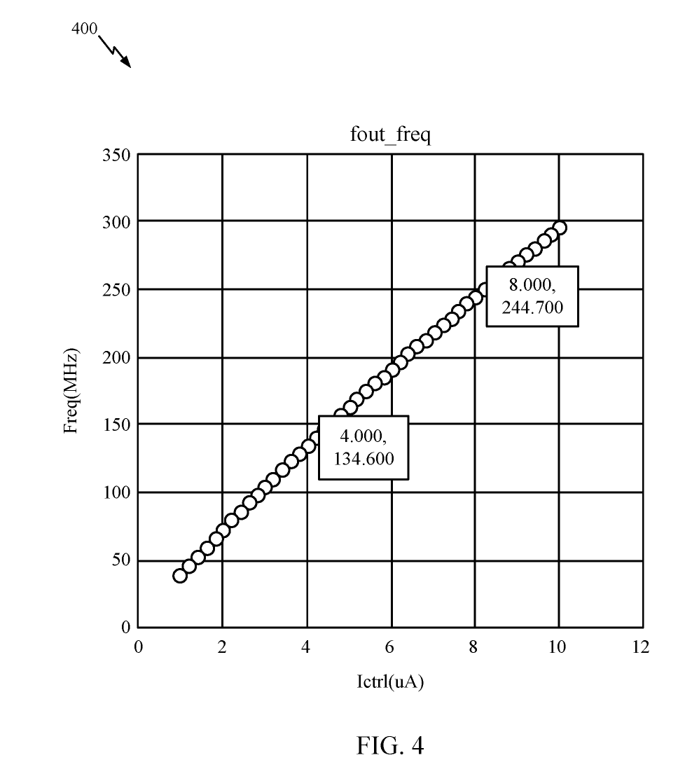

FIG. 4 is a graph 400 illustrating a frequency of the oscillating signal (osc_out) as a function of Ictrl, in accordance with certain aspects of the present disclosure. Ideally, doubling the biasing current of the oscillator 204, should double the frequency of osc_out, however, in reality, this is not the case. For example, as illustrated by the graph 400, an Ictrl of 4 uA may provide a frequency of 134.6 MHz at the output of the oscillator 204, and an Ictrl of 8 uA may provide a frequency of 244.7 MHz, which is less than twice the frequency 134.6 MHz at the 4 uA control current. Moreover, the control current versus output frequency of the oscillator 204 may be non-linear, causing accuracy issues during analog to digital conversion.

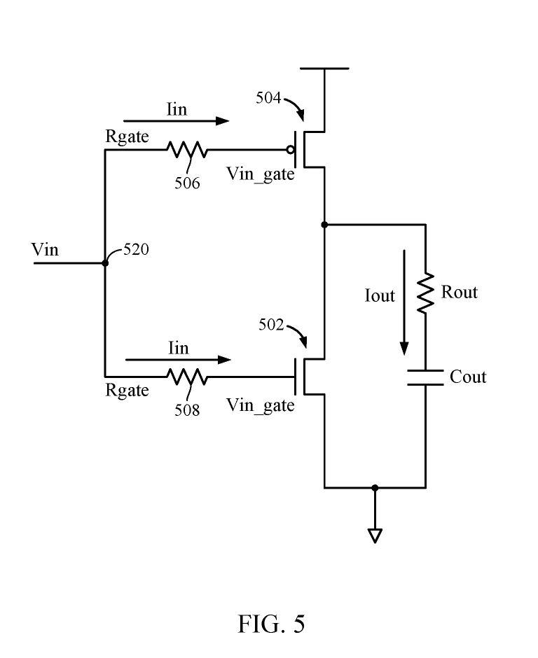

FIG. 5 is an example inverter (e.g., inverter 216₁) that may be used in the oscillator 204, in accordance with certain aspects of the present disclosure. As illustrated, the inverter may include a n-channel metal oxide semiconductor (NMOS) transistor 502 and a p-channel metal oxide semiconductor (PMOS) transistor 504, each having a parasitic gate resistance, represented by resistors 506 and 508 (Rgate). This gate resistance is a contributor to the non-linearity shown in the graph 400 of FIG. 4 because the threshold at which the output of the inverter switches between logic high and logic low changes due to the gate resistance. For example, the input voltage to the gate (Vin_gate) may be calculated as:

Vin_gate=Vin −Iin×Rgate

where Vin is the input voltage at node 520, and Iin is the input current to the gate of the transistor (e.g., transistor 502 or 504), as illustrated in FIG. 5. The higher the resistance of Rgate, the higher Vin needs to be to properly bias the gates of the transistors 502 and 504, resulting in a larger non-linearity for the inverter.

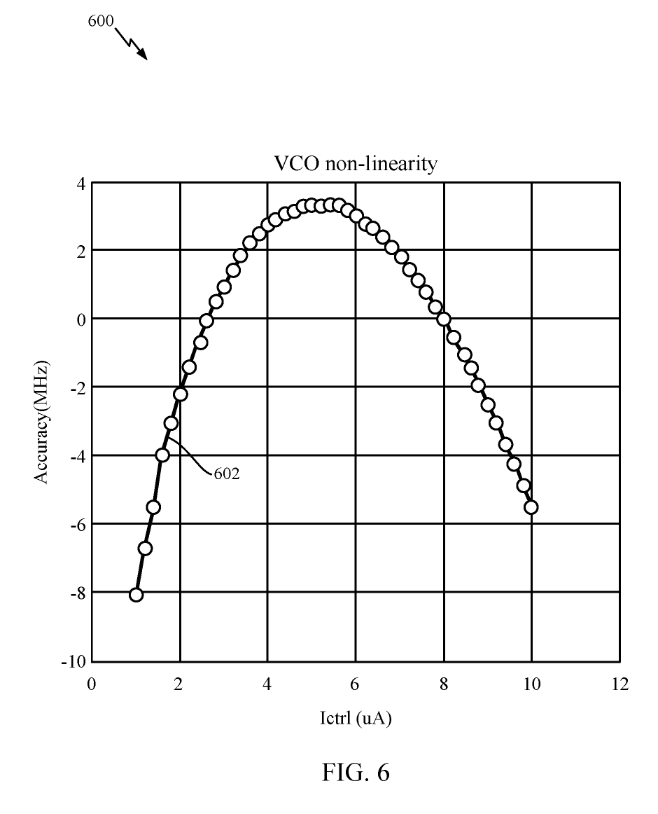

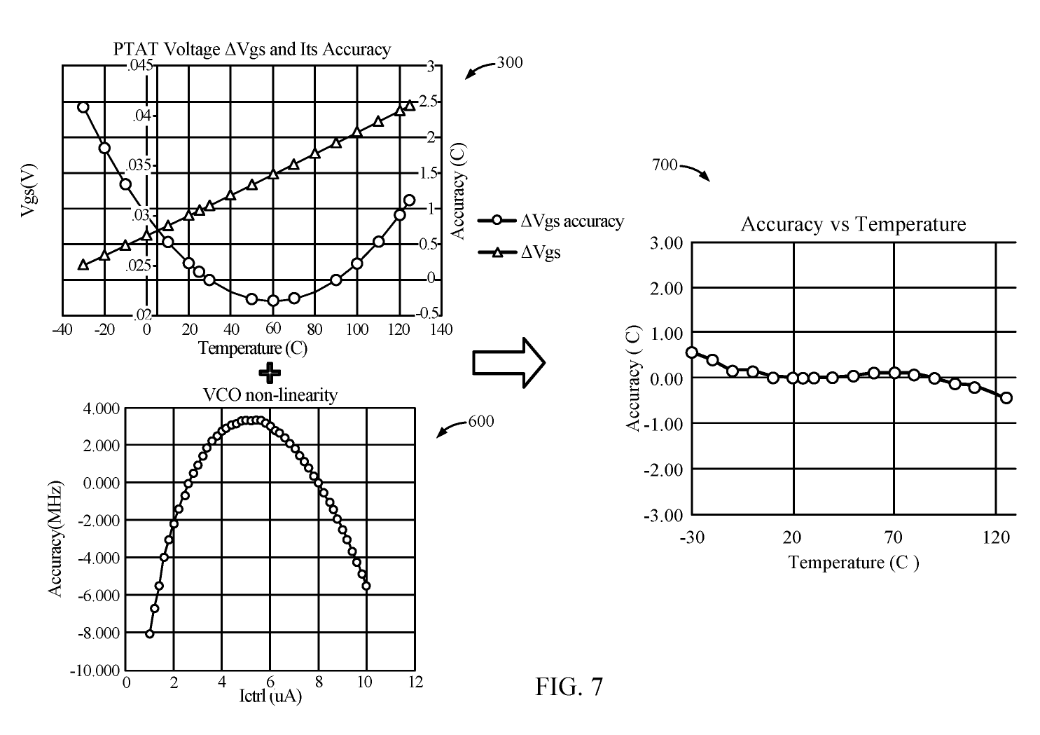

FIG. 6 is a graph 600 illustrating the accuracy of the oscillator 204 as a function of Ictrl, in accordance with certain aspects of the present disclosure. As illustrated, if the frequency versus control current of the oscillator 204 is calibrated using a linear curve at 3 uA and 8 uA, the curve 602 representing the accuracy of the oscillator 204 has a downwards curvature. This is opposite to the accuracy curve 302 of the PTAT current generation circuit 202 as illustrated in FIG. 3 which has an upwards curvature. Therefore, by generating the Ictrl for the oscillator 204 based on the PTAT current 224, the non-linearity of the oscillator 204 compensates for the non-linearity of the PTAT current generation circuit 202, providing a more accurate temperature readout, as illustrated in FIG. 7. For example, as illustrated by graph 700 of FIG. 7, the accuracy of the temperature sensing circuit 200 may be less than 1° C. Moreover, the temperature sensing circuit 200 may be operated using a low power supply voltage, and thus, may be operated using a digital power supply, avoiding routing of an analog power supply to the temperature sensing circuit 200.

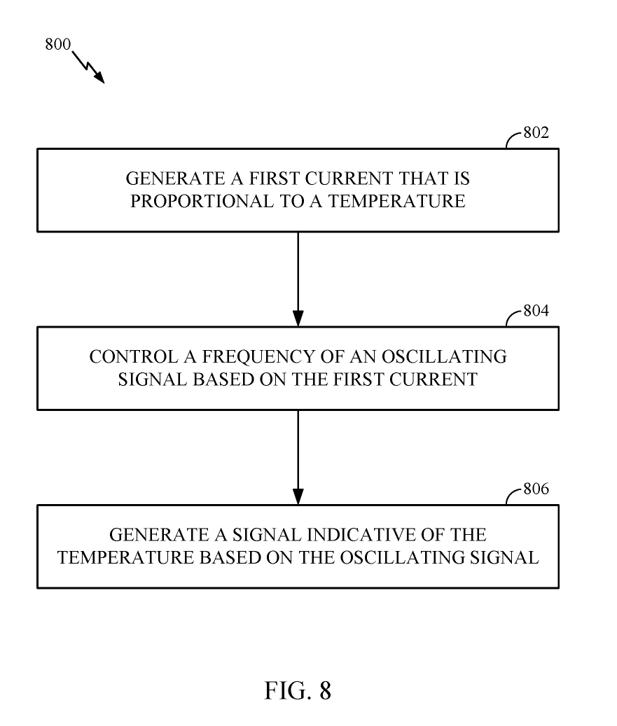

FIG. 8 is a flow diagram of example operations 800 for sensing a temperature, in accordance with certain aspects of the present disclosure. The operations 800 may be performed, for example, by a temperature sensing circuit, such as the temperature sensing circuit 200.

Operations 800 may begin, at block 802, by generating a first current (e.g., the PTAT current 224) that is proportional to the temperature, and at block 804, by controlling a frequency of an oscillating signal (e.g., osc_out signal generated by oscillator 204) based on the first current. At block 806, a signal indicative of the temperature may be generated based on the oscillating signal. In certain aspects, controlling the frequency of the oscillating signal may include sourcing the first current to a supply node of a ring oscillator. In this case, the operations 800 may also include generating a second current that is proportional to the temperature, where controlling the frequency of the oscillating signal includes sinking the second current from another supply node of the ring oscillator. In some cases, generating the second current may include current mirroring the first current. In certain aspects, generating the signal indicative of the temperature may include generating (e.g., via the FDC 218) a digital signal indicative of the frequency of the oscillating signal.

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

In certain aspects, means for generating a first current and means for controlling a frequency may comprise a PTAT generation circuit, such as the PTAT current generation circuit 202. Means for generating a signal indicative of a temperature may comprise an oscillator, such as the oscillator 204. In certain aspects, means for sourcing, means for sinking, and means for current mirroring may comprise a current mirror and/or a transistor, such as the transistor 226 or 228.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A temperature sensing circuit, comprising:
a first current mirror having a first branch coupled to a first transistor;
a resistive element coupled between a source of the first transistor and a reference potential;
a second current mirror having a first branch coupled to a second transistor, wherein a source of the second transistor is coupled to the reference potential, wherein a gate of the first transistor is coupled to a gate of the second transistor; and
an oscillator having an input coupled to a third transistor of the second current mirror.

2. The temperature sensing circuit of claim 1, wherein the input of the oscillator is coupled to a fourth transistor, a gate of the fourth transistor coupled to a gate of the third transistor of the second current mirror.

3. The temperature sensing circuit of claim 2, wherein the oscillator comprises a ring oscillator, wherein the input of the oscillator comprises a power supply node of the ring oscillator coupled to a drain of the fourth transistor.

4. The temperature sensing circuit of claim 3, wherein the first current mirror is configured to:
generate a current that is proportional to a temperature; and
source the current to the power supply node of the ring oscillator.

5. The temperature sensing circuit of claim 3, further comprising:
a third current mirror having a first branch coupled to a second branch of the first current mirror, and having a second branch coupled to a second branch of the second current mirror, wherein another power supply node of the ring oscillator is coupled to a fifth transistor, a gate of the fifth transistor coupled to a gate of a sixth transistor of the third current mirror.

6. The temperature sensing circuit of claim 5, wherein the third current mirror is configured to:
generate a current that is proportional to a temperature; and
sink the current from the other power supply node of the ring oscillator.

7. The temperature sensing circuit of claim 1, wherein the first current mirror is configured to:
generate a current that is proportional to a temperature; and
control a frequency of the oscillator based on current.

8. The temperature sensing circuit of claim 1, wherein a second branch of the first current mirror is coupled to the gate of the first transistor.

9. The temperature sensing circuit of claim 1, further comprising:
a frequency to digital converter coupled to an output of the oscillator.

10. The temperature sensing circuit of claim 9, wherein the frequency to digital converter is configured to generate a digital signal based on a frequency of an oscillating signal at the output of the oscillator.

11. The temperature sensing circuit of claim 1, further comprising:
a capacitor coupled between the gate of the first transistor and the reference potential.

12. A method for sensing a temperature, comprising:
generating a first current that is proportional to the temperature;
controlling a frequency of an oscillating signal based on the first current; and
generating a signal indicative of the temperature based on the oscillating signal.

13. The method of claim 12, wherein:
the oscillating signal is generated via a ring oscillator; and
the controlling of the frequency of the oscillating signal comprises sourcing the first current to a supply node of the ring oscillator.

14. The method of claim 13, further comprising:
generating a second current that is proportional to the temperature, wherein the controlling of the frequency of the oscillating signal further comprises sinking the second current from another supply node of the ring oscillator.

15. The method of claim 14, wherein generating the second current comprises current mirroring the first current.

16. The method of claim 12, wherein generating the signal indicative of the temperature comprises converting the frequency of the oscillating signal to a digital signal.

17. An apparatus for sensing a temperature, comprising:
means for generating a first current that is proportional to the temperature;
means for controlling a frequency of an oscillating signal based on the first current; and
means for generating a signal indicative of the temperature based on the oscillating signal.

18. The apparatus of claim 17, wherein the means for controlling comprises means for sourcing the first current to a supply node of a ring oscillator.

19. The apparatus of claim 18, further comprising:
means for generating a second current that is proportional to the temperature, wherein the means for controlling the frequency of the oscillating signal further comprises means for sinking the second current from another supply node of the ring oscillator.

20. The apparatus of claim 19, wherein the means for generating the second current comprises means for current mirroring the first current.
